(19) United States
(12) Patent Application Publication
(10) Pub. No.: US 2026/0202626 A1
(43) Pub. Date: Jul. 16, 2026

(54) SYSTEMS AND METHODS FOR OPTICAL DEVICES

(71) Applicant: Taiwan Semiconductor Manufacturing Company, Ltd., Hsinchu (TW)

(72) Inventor: Feng-Wei KUO, Hsinchu (TW)

(73) Assignee: Taiwan Semiconductor Manufacturing Company, Ltd., Hsinchu (TW)

(21) Appl. No.: 19/245,721

(22) Filed: Jun. 23, 2025

Related U.S. Application Data
(60) Provisional application No. 63/745,537, filed on Jan. 15, 2025.

(51) Int. Cl. G02B 6/42

(52) U.S. Cl. CPC G02B 6/4214; G02B 6/4239; G02B 6/4245

(57) ABSTRACT

A method of semiconductor device fabrication is provided. The method includes providing a device including a photonic die having a grating coupler. The method includes patterning an upper surface of the device to form a lensing feature configured to receive light from an upper surface of the photonic die. The method includes forming a first mirror configured to optically couple the lensing feature with the grating coupler according to an angle of incidence between the light and the grating coupler of less than about 15 degrees.

### CROSS-REFERENCE TO RELATED APPLICATIONS

This application claims priority to and the benefit of U.S. Patent App. No. 63/745,537, filed Jan. 15, 2025, the entire disclosure of which is incorporated by reference herein.

### BACKGROUND

Optical devices, such as those used in silicon photonics, are employed in a variety of applications, including data communications, high-performance computing, sensing, and advanced imaging systems. Optical devices are fabricated by sequentially depositing insulating or dielectric layers, conductive layers, and optical waveguiding layers over a substrate, and by lithographic patterning to define optical circuit components and elements. As the silicon photonics industry has advanced to support higher data rates, improved energy efficiency, and greater integration with electronic systems, challenges related to fabrication precision, alignment, and optical loss have driven the development of novel packaging techniques.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example of a semiconductor device including a grating coupler, coupled with a light source, in accordance with some embodiments.

FIG. 2 illustrates another example of a semiconductor device including a grating coupler coupled with a light source, in accordance with some embodiments.

FIG. 3 illustrates yet another example of a semiconductor device including a grating coupler coupled with a light source, in accordance with some embodiments.

FIG. 4 illustrates an example flow chart of a method for optical coupling, in accordance with some embodiments.

FIG. 5 illustrates an example flow chart of a method for semiconductor device fabrication, in accordance with some embodiments.

FIGS. 6, 7, 8A, 8B, 9, 10, 11, 12, 13, 14, 15, and 16 illustrate example cross sectional views of a semiconductor device during various fabrication stages according to the method of FIG. 5, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Generally, semiconductor devices can couple with optical source (e.g., optical fiber) via edge coupling, where light is injected into waveguides without an intervening grating coupler, or vertical coupling, where light is directed into grating couplers perpendicular to the waveguides. Relative to edge coupling, the vertical coupling approach can suffer from greater losses (generally exceeding 3 dB), reduction in bandwidth, and polarization dependencies, among other issues. However, the vertical approach is often used, since the technique is generally compatible with reduced alignment precision, and greater surface area available for coupling (e.g., the surface of a semiconductor die generally substantially exceeds a surface area of its edges). Moreover, edge-coupling can increase a lateral footprint of the semiconductor device, as may encourage the use of vertical coupling. Vertical coupling generally includes index matched coupling between a vertically oriented light source and a grating coupler. For example, an optical fiber can couple to a die (e.g., via an optical gel).

According to the present disclosure, light is provided from a vertical light source to the grating coupler at a shallow angle, including an angle of less than about 15 degrees (e.g., about two degrees). The light source can include an optical fiber which terminates extending along a lateral direction for a semiconductor device. Accordingly, light emitted from the light source can be provided generally parallel to a lateral surface of the semiconductor device. A tuning mirror can redirect the light to a silicon-based lensing feature, such as a bulk silicon (e.g., monocrystalline silicon) or silicon nitride (Si₃N₄) lensing feature. The lensing feature can collimate the light prior to its receipt by a second mirror. For example, the light source can extend above the lensing feature such that the tuning mirror can redirect the light downwards through the lensing feature to the second mirror. The second mirror can, in turn, redirect the light towards the grating coupler at the shallow angle. Upon receipt, the grating coupler can couple the light with a waveguide, as may interface with an electronic die coupled with the photonics die including the waveguides, to perform various computational functions.

According to the angle of incidence between the grating coupler and the light, substantial performance improvements can be realized, relative to other approaches using vertical coupling (e.g., improved bandwidth). Device performance can approach (or even exceed) performance of an edge coupled device, in at least some circumstances. Moreover, certain of the complexities or disadvantages of edge-coupling can be avoided.

The light source can be provided temporarily, as for an end-of line test, or permanently, as an integral component of the semiconductor device. Moreover, even when provided as an integral component, the light source can be coupled with other portions of the semiconductor die according to a post-back end of line process. Accordingly, the present disclosure contemplates the depicted examples of semiconductor devices formed in their totality, as well as constituent portions thereof. For example, a first portion including the light source coupled with a tuning mirror and configured to couple with a substrate portion of a semiconductor device (e.g., via an alignment feature), can be referred to as one semiconductor device. A second portion including the collimating lens along with another mirror and the grating coupler can be referred to as another semiconductor device. Upon their (temporary or permanent) coupling, the resulting assemblage may also be referred to a (e.g., one) semiconductor device, or as a system including the two constituent semiconductor devices, without limiting effect.

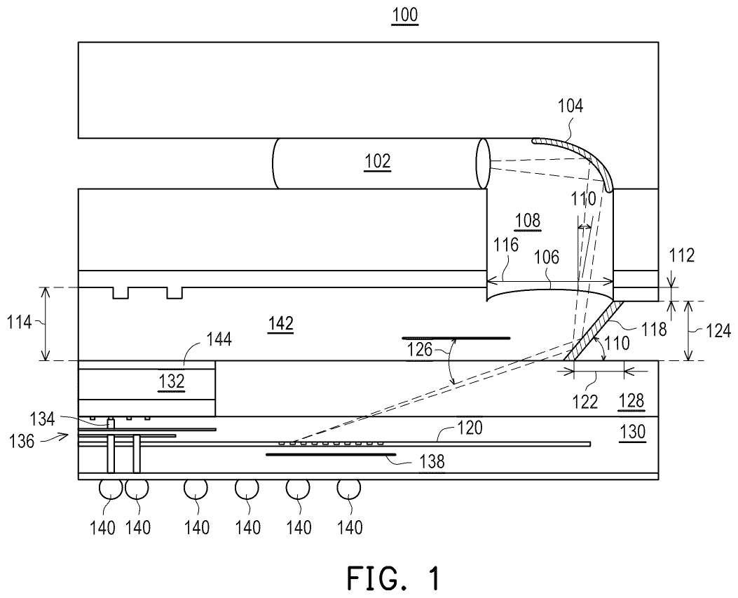

FIG. 1 illustrates an example of a semiconductor device 100 including a grating coupler 120 coupled with a light source 102, in accordance with some embodiments. The light source 102 is depicted as an optical fiber, as may include single mode fiber, lensed fiber, high numerical aperture fiber, and so forth. The particular fiber can be selected according to a desired bandwidth, alignment sensitivity, and loss, among other criteria. References to the light source 102 can include at least a terminus of the optical fiber (although such a source can ultimately receive light from an upstream source disposed at an opposite terminus). Additionally, further light sources 102 are contemplated, as may include laser diodes or other aspects of further semiconductor dies. At least the depicted terminal portion of the light source 102 extends substantially perpendicular to a lateral surface of the semiconductor device 100. In some embodiments, a tolerance for the light source 102 can deviate somewhat (e.g., within a few degrees). Various downstream components can extend somewhat beyond an expected position of the light beam to account for such deviation, and can be curved or lensed to correct such deviations, at least partially. In some embodiments, an intended path for the light source 102 can deviate from a central portion of the lateral surface somewhat, as may aid in the tolerance of subsequent features, or to aid their fabrication (e.g., where certain angles, such as about 45 degrees are more easily fabricated, according to certain operations).

The light source 102 provides light (along the lateral surface) to a tuning mirror 104. The tuning mirror 104 can redirect the light to deviate from a vertical direction by about 5-15 degrees (e.g., about 12 degrees). As depicted, the tuning mirror 104 can be provided as a curved mirror configured to focus any redirected light, as may aid in the subsequent collimation of the light, or reduce a dimension of downstream features due to increased alignment precision. The tuning mirror 104 can couple with at least one of the light source 102 or a lensing feature 106 via an air gap 108, as depicted. In some embodiments, the air gap 108 can be substituted for another gap, such as an index matched gas, vacuum sealed cavity, or a gap to provide mechanical support or electrical isolation such as an aerogel or low-index polymer. For this reason, an angle between a vertical axis and the light, as redirected from the tuning mirror 104, is sometimes referred to as an air angle 110, without limiting effect. For example, the deviation on the vertical direction of about 5-15 degrees (e.g., about 12 degrees) can be referred to as an air angle 110. The light extends through the air gap 108 to the lensing feature 106 at the air angle 110.

The lensing feature 106 can be formed in a silicon-containing layer 142, which includes silicon (e.g., consists essentially of silicon). For example, monocrystalline silicon can provide reduced losses, scattering, and absorption, relative to other approaches. The lens thickness 112 can extend between about 1 micrometer (μm) and about 50 μm. For example, a lens thickness 112 of about 5 μm can effectively collimate received light, in some embodiments. The overall thickness 114 of the silicon-containing layer 142 can be provided as between about 100 μm and about 1000 μm (e.g., greater than about 300 μm in an embodiment, such as greater than about 700 μm). This thickness 114 can provide mechanical support, thermal isolation, and so forth. Accordingly, the silicon-containing layer 142 can be provided as a substrate with other depicted components formed thereon of coupled thereto. In some embodiments, at least a portion of the silicon-containing layer 142 (e.g., at least the lens portion) can include silicon nitride, as may improve optical efficiency for lower frequency signals (e.g., below about 1.1 μm wavelength). In some embodiments, a silicon nitride substrate is provided, among other materials configured to provide an optical path for the light. A curvature radius of the lensing feature 106 can be provided as between about 100 μm and about 1000 μm (e.g., larger than about 600 μm).

A diameter 116 of the lens can be defined according to the provided ranges of curvatures and thicknesses. For example, a lens diameter 116 can be provided as between about 100 μm and about 200 μm, as can avoid incident light loss. The diameter 116 can (but need not be) be anisotropic, as in the case of an elliptical lens. Accordingly, the ranges provided can refer to a major or minor axis of the ellipse, as depicted in the present cut plane. Indeed, various portions of the lensing feature 106 can be provided asymmetrically, in some embodiments. For example, where only a subset of the lens surface receives substantial light from the tuning mirror 104, other portions of the lensing feature 106 can be provided to compensate for alignment deviations, or can be omitted to simplify device fabrication or improve density. More particularly, the lensing feature 106 can be configured to receive the light along a portion (e.g., hemisphere, as depicted), or can be provided as a hemispherical lens. Accordingly, the collimation can adjust a propagation angle of the light relative to the air angle 110, at least somewhat. In some embodiments, the tuning mirror 104 can focus the light to another lens portion, such as a geometric or optical center, as may aid to increase alignment tolerances or reduce feature sizes.

Upon passing through the lensing feature 106, collimated light can continue through a remaining portion of the silicon-containing layer 142 (e.g., a substrate) to another mirror 118 configured to redirect the light to the grating coupler 120. The redirection can provide the light to the grating coupler 120 at an angle of incidence configured to improve the bandwidth of coupling light into waveguides, relative to a perpendicular intersection (e.g., shallow incident angles, similar to an edge coupled device). Such a mirror 118 can exhibit a lateral width 122 in the present cut plane (e.g., maximum diameter) of between about 1 μm and about 700 μm (e.g., larger than about 100 μm). The height 124 of the mirror 118 can be somewhat similar. For example, a height can be provided between about 1 μm and about 1000 μm (e.g., larger than about 300 μm). A mirror angle 126 for the mirror 118 can be provided as larger than or within 10 degrees of 45 degrees, such as about 55 degrees. Angles larger than 45 degrees can increase deflection to improve an angle of indigence with the grating coupler 120, while angles closer to 45 degrees can ease manufacturing of the mirror 118.

The geometric or optical center of the lensing feature 106 can be provided in-line with the mirror 118 (with zero vertical offset), or can be offset therefrom. For example, the geometric or optical center of the lensing feature 106 can be offset from the geometric or optical center of the mirror 118 by up to about 50 μm, in some embodiments. In some embodiments, the mirror 118 includes or consists essentially of one or more metals, such as a copper, gold, titanium nitride, tantalum nitride, aluminum, or other metals.

The mirror 118 provides substantially collimated light to the grating coupler 120 at a relatively shallow mirror angle 126 of between about 1 degree and about 15 degrees (e.g., about 2 degrees). A sweep point of the grating coupler 120 is a portion which couples with the waveguide at a maximum efficiency. A distance to the sweep point of the grating coupler 120, as defined by the mirror angle 126 and a thickness of any intervening layers, can be provided as between about 1 μm to about 1000 μm (e.g., greater than about 120 μm). For example, intervening layers can include an oxide layer 128 and a portion of a photonics die 130 (p-die 130) above the grating coupler 120. The oxide layer 128 can be between about 0 μm and 50 μm. For example, the oxide layer 128 can be substantially similar to a thickness of an electronic die 132 (e-die 132) operatively coupled with the p-die 130, via various via structures, such as a bonded photonic via structures 134 or various metallization or waveguide layers 136, as may couple the p-die 130 and the e-die 132, and contribute to a vertical distance between the mirror 118 and the grating coupler 120. The e-die 132 can include a further layer 144 including silicon having a thickness of between about 0.1 to 1 μm, as may be laterally spaced from the oxide layer 128 and separate the e-die 132 from the other silicon-containing layer 142. The p-die 130 or the e-die 132 can further couple with device terminals 140, as can include intermediate terminals to couple with an interposer, circuit board, or further substrates.

The grating coupler 120 can be provided as a multi-trench grating coupler 120 having varying spacings and shapes to improve noise rejection and to obtain high-bandwidth performance. However, like other aspects of the present disclosure, such features can be modified (e.g., to provide improved rejection at a particular frequency and improve rejection of any known or uncharacterized interference). The p-die 130 can include a backside reflector 138 to improve coupling efficiency between the grating coupler 120 and any waveguides or other photonic circuits.

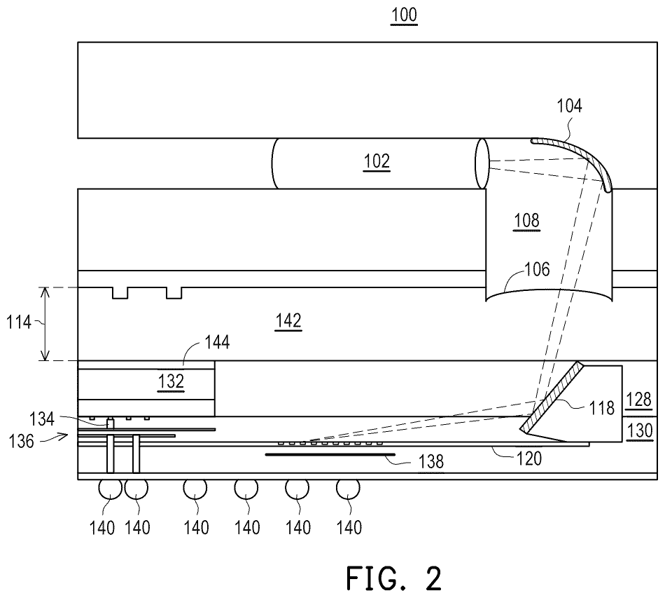

FIG. 2 illustrates another example of a semiconductor device 100 including a grating coupler 120 coupled with a light source 102, in accordance with some embodiments. According to the depicted embodiment, the mirror 118 is formed in at least one of the oxide layer 128 or the p-die 130. Such an approach can reduce a vertical spacing between the mirror 118 and the grating coupler 120. The reduced vertical spacing can, in turn, reduce an ingle of incidence between the grating coupler 120 and light received thereby, or reduce a lateral spacing between the grating coupler 120 and the mirror 118. A reduction to the angle of incidence can improve a bandwidth, or efficiency of optical coupling between the grating coupler 120 and a waveguide or other photonic component of the p-die 130. A reduction to the lateral spacing can improve device density, as more circuits can be included in per unit of lateral space.

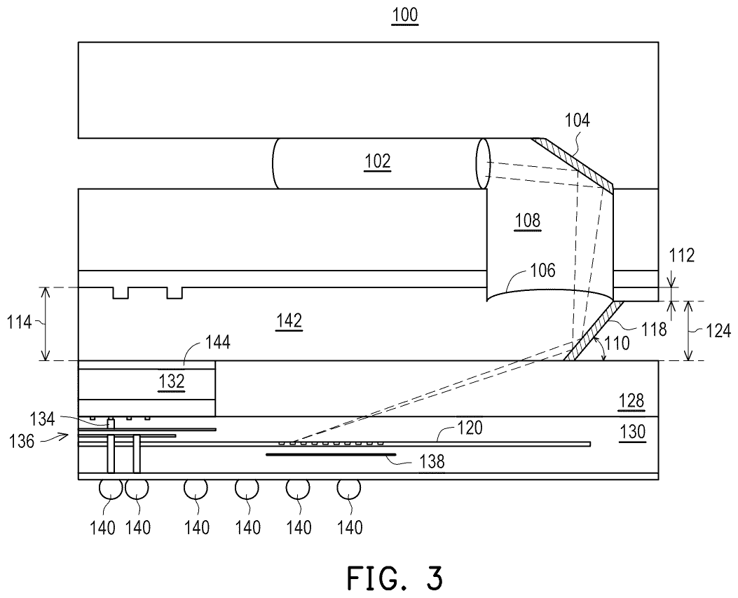

FIG. 3 illustrates yet another example of a semiconductor device 100 including a grating coupler 120 coupled with a light source 102, in accordance with some embodiments. The tuning mirror 104 is depicted as generally flat, as may reduce a complexity of certain manufacturing operations. In some embodiments, the tuning mirror 104 is angled at about 45 degrees (e.g., plus or minus ten degrees), as may further simplify its manufacture. Although the planar tuning mirror 104 can exhibit reduced focusing of light relative to the curved examples depicted in FIGS. 1-2, the optical assembly can exhibit improved performance relative to various vertical coupling techniques. Moreover, other aspects of the semiconductor device 100, such as the radius of the lensing feature can be adjusted relative to embodiments employing a curved tuning mirror 104, as may mitigate an impact to device performance.

In the depicted example, the tuning mirror 104 redirects light received from the light source 102 to a mirror 118, similar to the mirror 118 of FIG. 1. However, in some embodiments, the planar tuning mirror 104 can redirect light to a mirror 118 vertically spaced from the silicon-based portion of the semiconductor device 100, such as vertically aligned with the oxide layer 128 or the p-die 130 (e.g., the mirror 118 of FIG. 2). Indeed, various aspects of the present figures can be omitted, substituted, or exchanged according to the various features provided in the present disclosure, or other known features of silicon-photonic or related devices.

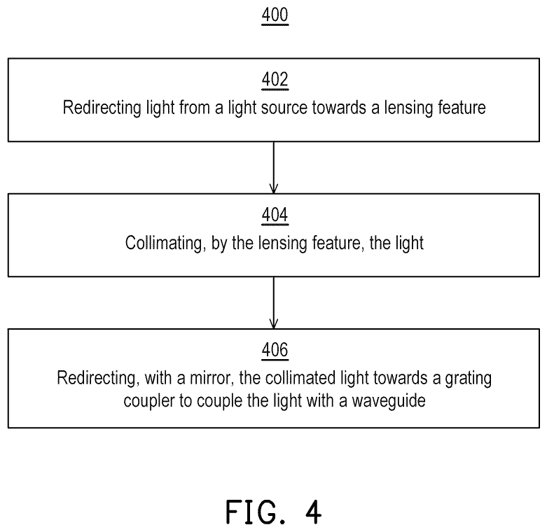

FIG. 4 illustrates an example flow chart of a method 400 for optical coupling, in accordance with some embodiments. For example, the present method can be performed with various semiconductor devices 100 of the present disclosure, such as the semiconductor devices 100 of FIGS. 1-3, or those provided hereinafter. It should be noted that the method 500 is merely an example, and is not intended to limit the present disclosure. Accordingly, it is understood that additional operations may be provided before, during, or after the method 400 of FIG. 4, and that some other operations may only be described briefly described herein.

In brief overview, the method 400 starts with operation 402 of redirecting light from a light source 102 to a lensing feature 106. Next, the method 400 proceeds to operation 404 of collimating the light. Next, the method 400 proceeds to operation 406 of redirecting the collimated light towards a grating coupler.

In further detail, at operation 402, a semiconductor device 100 can redirect light received from a light source 102, as may include an optical fiber, towards a lensing feature 106 disposed vertically below the light source 102. For example, the light source 102 can refer to an optical fiber having a terminal portion extending parallel to the semiconductor device 100 (e.g., along an upper surface). In some embodiments, the optical fiber can extend vertically above a semiconductor device 100, and include a curvature to transition to the lateral portion including the terminus. Redirecting the light received from the light source 102 can include passing the light from the terminus of the optical fiber, though an air gap 108, to a first mirror (a tuning mirror 104). For example, the tuning mirror 104 can have a curved surface, as depicted in FIGS. 1-2, or a planar surface, as depicted in FIG. 3.

In further detail, at operation 404, the curved surface of the tuning mirror 104 can converge the light through the air gap 108 towards a focal point on the second mirror (e.g., a planar surface of mirror 118). For example, the curved surface of the tuning mirror 104 can redirect the light to the lensing feature 106 to collimate the light prior to its arrival at the second mirror 118. Of course, references to collimation or convergence should not be construed to require perfect results. For example, the converged light can exhibit some defocusing, and the collimated light can exhibit some residual divergence.

In further detail, at operation 406, the second mirror 118 can redirect the collimated light towards a grating coupler 120 to couple the light with a waveguide. For example, the second mirror 118 can provide the light at a shallow angle of less than about 15 degrees (e.g., about two degrees). Such an angle can improve bandwidth and coupling efficiency relative to a steeper angle (e.g., perpendicular interface). A backside reflector 138 or other features can further improve coupling efficiency.

The waveguide can, in turn provide the light to various circuits of the photonic die 130 as can be used to perform various computational functions (e.g., logic-or memory-based functions) within the photonic die 130 including the waveguide. Further, the photonic die 130 can couple with an electronic die 132. For example, the method 400 can include providing an indication of a detection of the light to the electronic die 132 using a bonded photonic via structure 134 communicatively coupled with the electronic die 132 (as may, in turn, be used to execute further computational functions on the electronic die 132, or in combination between the electronic die 132 and the photonic die 130). The indication, like other inputs or outputs for the photonic die 130 and the electronic die 132, can further couple with device terminals 140, as may be coupled with either of the photonic die 130 or the electronic die 132.

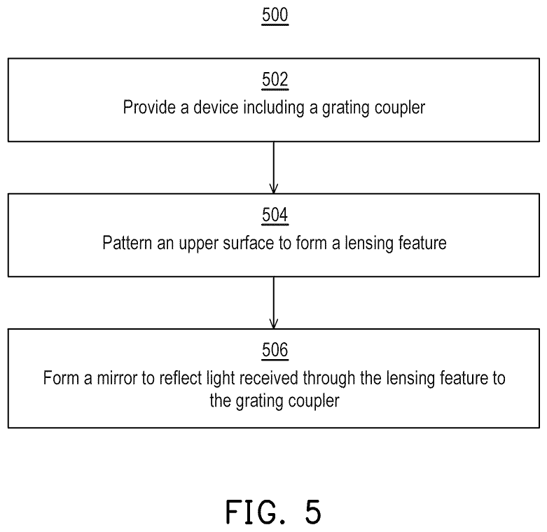

FIG. 5 illustrates a flow diagram for a method 500 of semiconductor device fabrication, in accordance with some embodiments. For example, at least some of the operations (or steps) of the method 500 may be used to form the semiconductor device 100 of any of FIGS. 1-3, as well as various further devices including combinations or substitutions of the features depicted therein. Upon their fabrication and integration into various computational systems, the semiconductor device 100 formed according to the present method 500 can perform the method 400 of FIG. 4. It should be noted that the method 500 is merely an example, and is not intended to limit the present disclosure. Accordingly, it is understood that additional operations may be provided before, during, or after the method 500 of FIG. 5, and that some other operations may only be described briefly described herein. For example, some anti-reflective coatings used in lithographic processes can affect a reflection index of the various mirrors, lensing features 106, and other components of the present disclosure.

In brief overview, the method 500 starts with operation 502 of providing a device including a photonic die 130 having a grating coupler 120. Next, the method 500 proceeds to operation 504 of patterning an upper surface of the device (e.g., of a substrate) to form a lensing feature 106 configured to receive light from an upper surface of the device. Next, the method 500 proceeds to operation 506 of forming a mirror 118 configured to optically couple the lensing feature 106 with the grating coupler 120.

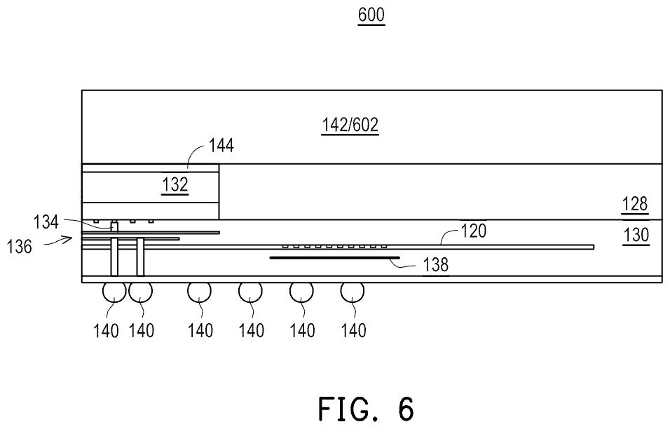

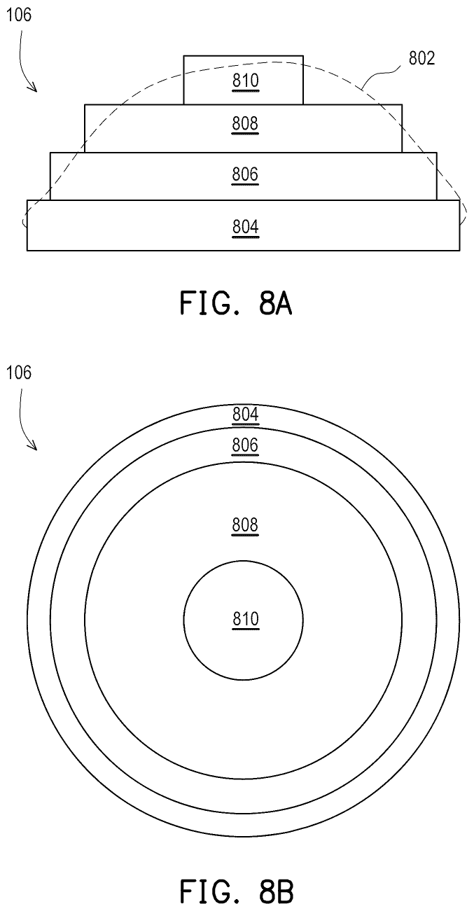

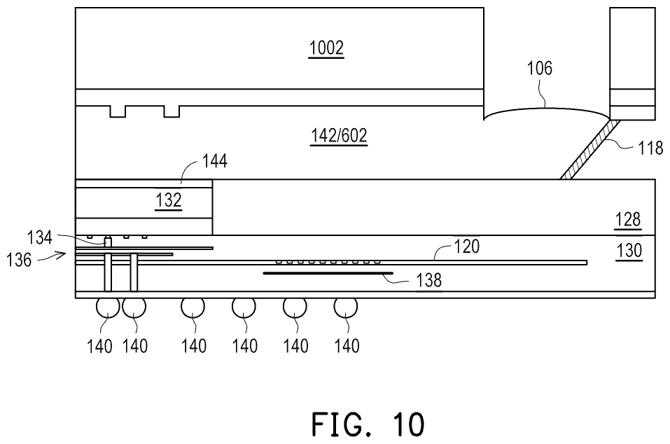

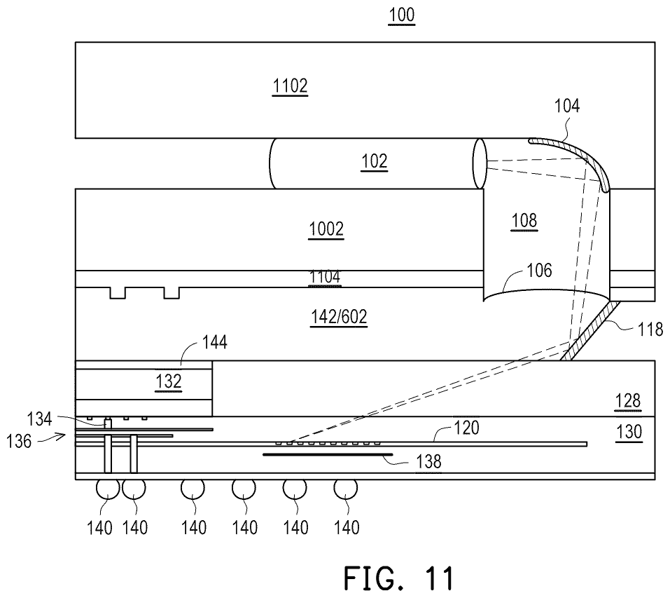

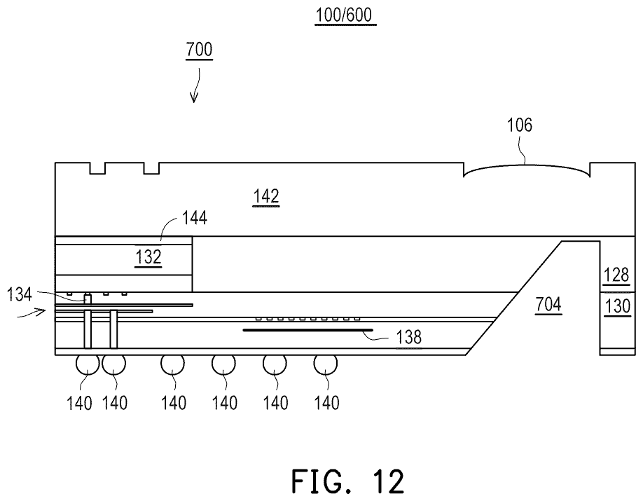

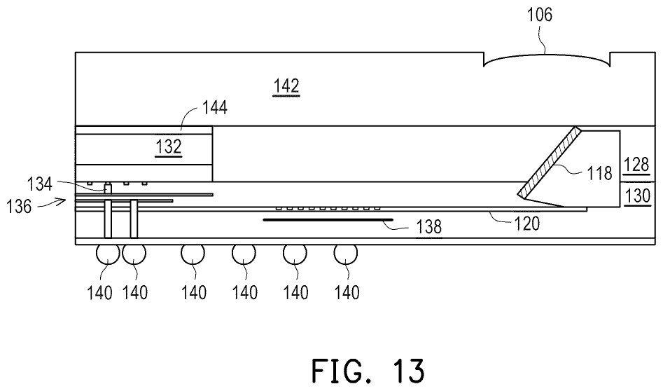

Referring generally to FIGS. 6-13, cross sectional views of a semiconductor device 100 during various fabrication stages according to the method of FIG. 5 are provided. More particularly, FIGS. 6-11 depict cross sectional views of an embodiment including a mirror 118 in the silicon-containing layer 142 (e.g., the semiconductor device 100 of FIG. 1). FIGS. 12-13 depict cross sectional views of an embodiment including a mirror 118 in the dielectric layer 128 or p-die 130. FIGS. 6, 8A, 8B can also correspond to such an embodiment. Although not depicted to avoid substantial duplication, a light source 102 can be coupled with the embodiment of FIGS. 12-13 according to the description of FIGS. 10-11. Further, the light source 102, tuning mirror 104, and other aspects of FIG. 10-11 can be substituted to realize further embodiments still (e.g., as depicted in FIG. 3).

Corresponding to operation 502 of FIG. 5, FIG. 6 illustrates a device (e.g., a semiconductor device 100) including a gating coupler 120 of a photonic die 130. For example, the device can include an electronic die 132 and an oxide layer 128 coupled with the photonic die 130, as described with regard to FIGS. 1-3. The depicted device can be formed by coupling an upper surface of the photonic die 130 with a lower surface of the electronic die 132, as is depicted. A dielectric layer 128 (e.g., an oxide layer) can provide mechanical support for a portion of the photonic die 130 not mechanically interfaced with the electronic die 132. Such an arrangement can provide an optical path for light through the dielectric layer 128 to the grating coupler 120, with the electronic die 132 disposed proximal to the waveguide to improve transmission losses and latency, relative to other device geometries. Of course, the illustrated geometry should not be construed as limiting, and various further device geometries are contemplated, as may vary according to their function. The dielectric layer 128 and the electronic die 132 can couple with a substrate 602, such as a monocrystalline silicon substrate 602 or a silicon nitride substrate 602, or further silicon-containing layers 142 can be provided. In some embodiments, the silicon-containing layers 142 can be substituted for other materials configured to lens and pass a frequency for a radiation of interest (e.g., photons).

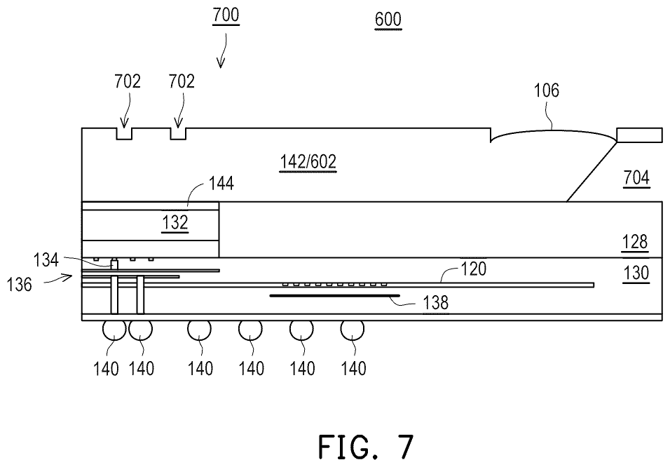

Corresponding to operation 504 of FIG. 5, FIG. 7 illustrates a device 600 (e.g., a semiconductor device 100) including a patterned upper surface 700. The patterned upper surface 700 includes alignment features 702, as may aid positioning of the semiconductor device 100. For example, the alignment features 702 can be provided as a fiducial marking to aid in the forming of further layers stacked over the semiconductor device 100. The patterned upper surface 700 includes the lensing feature 106, as well as a cavity 704 extending below the lensing feature 106. At least the alignment features 702 and the lensing feature 106 can be formed according to a same removal process, as is described further with regard to FIGS. 8A and 8B.

The cavity 704 can be formed from a same or another removal process. For example, in some embodiments, the cavity 704 is formed by providing an etchant through the upper surface 700, such as by replacing a cap over the cavity 704 after its removal, or performing an under etch using a wet etchant to maintain an upper surface of the substrate 602. In some embodiments, the upper surface of the substrate 602 is not maintained (e.g., the cavity 704 can be an opening exposed to the upper surface 700). In some embodiments, the cavity 704 (and potentially a mirror 118 formed therein) is formed from a backside of the substrate 602 (e.g., before coupling with or forming the dielectric layer 128 or the electronic die 132). Device terminals 140 are depicted as coupled with the photonic die 130, as can carry computational inputs or outputs related to the photonic die 130 or the electronic die 132.

With continued correspondence to operation 504 of FIG. 5, FIG. 8A depicts a profile view of the lensing feature 106, according to an illustrative environment. Various stair stepped levels can approximate a radius of curvature 802 of the lensing feature 106. Each of the stair stepped levels can be formed according to various positive or negative photolithographic processes. Moreover, according to corner roll-off from the removal (e.g., etching) of the various levels, the lensing feature 106 can align even more closely with the radius of curvature 802 than the depicted example including vertical sidewalls. Moreover, a number of steps can be adjusted to improve conformance between the stairstep levels and a target curvature. For example, the depicted example includes n of 4 steps, resulting in a first level 804, second level 806, third level 808, and fourth level 810. A 5-, 6-, or 7-step example can exhibit increased matching to a targe curvature, but increase manufacturing complexity. Conversely, a 3-step example can exhibit decreased matching to a target curvature, but decrease manufacturing complexity.

FIG. 8B depicts a top view of the lensing feature 106. More particularly, the lensing feature 106 of FIG. 8B depicts a circular lensing feature 106. Further examples can include elliptical or other non-symmetric lensing features 106. The same etching process used to form the depicted lensing feature 106 can be used to form alignment features 702. For example, a same mask pattern can be used for n steps to form alignment features 702 having substantially vertical sidewalls, relative to the surface of the lensing feature 106.

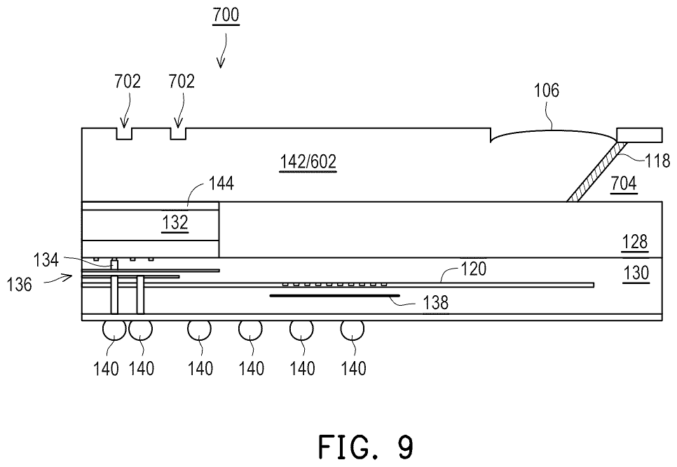

Corresponding to operation 506 of FIG. 5, FIG. 9 illustrates a device (e.g., a semiconductor device 100) including a mirror 118 formed in the silicon-containing layer 142 (e.g., the substrate 602). The mirror 118 can be formed according to various processes according to a particular device flow. For example, a metal of the mirror 118 can be deposited along a sidewall of the cavity 704 according to a conformal process (e.g., a conformal process selective to the silicon-containing layer 142). In some embodiments, the mirror 118 can be formed by depositing metal using an electroplating process. Accordingly, the mirror 118 can fill the cavity 704, as may later be removed, in part, leaving the depicted mirror 118 (or the other metal can be left in place). According to various embodiments, the mirror 118 can be formed from material deposited through an upper surface 700 of the silicon-containing layer 142, or a backside (e.g., prior to forming the dielectric layer 128, or through a backside opening of the dielectric layer 128).

With further correspondence to the method 500 of FIG. 5, FIG. 10 illustrates coupling an adhesive 1002 with the silicon-containing layer 142 (e.g., the substrate 602). The adhesive 1002 is configured to couple a light source 102 with the device formed according to operations 502-506. For example, the light source 102 can be provided along with a tuning mirror 104 and a further substrate, as is depicted in FIG. 11.

In some embodiments, the adhesive 1002 is provided as a permanent bonding adhesive 1002. For example, where the light source 102 is an operational component of the semiconductor device 100, a permanent adhesive 1002 can couple the light source 102 with other portions of the device, as an integral portion of the semiconductor device 100. In some embodiments, the adhesive 1002 is provided as a de-bondable adhesive 1002, as in the case of a temporary coupling (e.g., for an end-of-line test, wherein the light source 102 is a test device). For example, the adhesive 1002 can be provided to mechanically couple the light source 102 and a second mirror (the tuning mirror 104) with the device. The light source 102 can be used to test the photonic die 130 or an electronic die 132 coupled with the photonic die 130. Subsequent to testing, the de-bondable adhesive 1002 can be removed. For example, radiation (e.g., UV light) can be used to de-bond a photo-sensitive adhesive 1002, heat can be applied to de-bond a thermal sensitive adhesive 1002, or a solvent can be used to de-bond a solvent-sensitive adhesive 1002. Further temporary bonding adhesives can be released according to further corresponding suboperations (e.g., pressure sensitive adhesives, electro-releasable adhesives, and so forth).

With further correspondence to the method 500 of FIG. 5, FIG. 11 illustrates a light source 102 and tuning mirror 104 coupled with the adhesive 1002 (along with a further substrate 1102, as may be provided as a semiconductive or carrier substrate 1102). As depicted, the light source 102 is optically coupled to pass the light along a lateral surface of the device with the lensing feature 106. The tuning mirror 104 redirects the light to the lensing feature 106 according to an alignment between the tuning mirror 104 and the lensing feature 106 (and so on for a further mirror 118, grating coupler 120, waveguides, and so forth).

The alignment feature 702 can be used to maintain alignment between the tuning mirror 104 and other components of the semiconductor. In some embodiments, the alignment feature 702 can be used to apply the adhesive 1002, as may include its own alignment feature 702 to couple with the light source 102. In some embodiments, the alignment feature 702 is detectable (e.g., visible) through the adhesive 1002. In some embodiments, the adhesive 1002 is coupled with the light source 102, further substrate 1102, and tuning mirror 104 prior to mechanical coupling with the other portions of the semiconductor device 100. In some embodiments, an intermediate layer 1104 separates the adhesive 1002 from the silicon containing layer 142 (e.g., substrate 602), as may improve alignment realization. Numerous alignment features 702 can couple numerous light sources 102 to corresponding lensing features disposed over a surface of the semiconductor device 100, as may realize density of several optical fibers per square millimeter, or higher effective densities for certain devices, such as those using optical ribbons.

Corresponding to operation 504 of FIG. 5, FIG. 12 illustrates a device 600 (e.g., a semiconductor device 100) including a patterned upper surface 700. The patterned upper surface 700 is provided similarly to the upper surface 700 of FIG. 7. However, the cavity 704 of the silicon-containing layer 142 of FIG. 7 is omitted, and another cavity 704 is provided in at least one of the dielectric layer 128 or the p-die 130. For example, the cavity 704 can be formed according to a backside etch of the p-die 130, a spacer formed in the dielectric layer 128 (e.g., a spacer formed prior to forming the dielectric layer 128 over the substrate 602), or various further techniques.

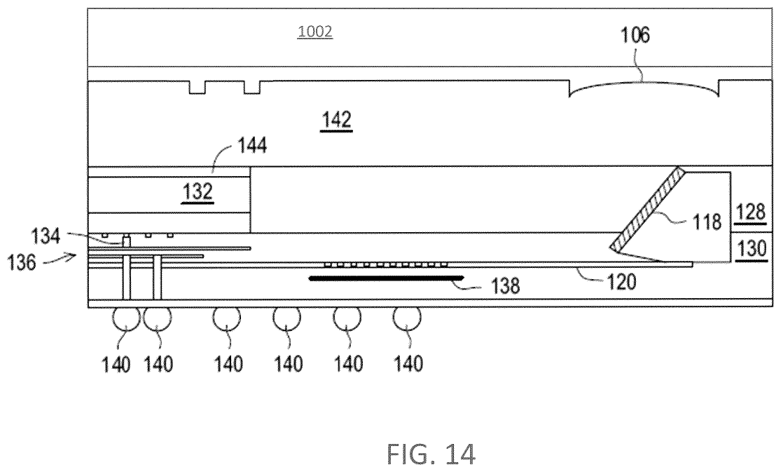

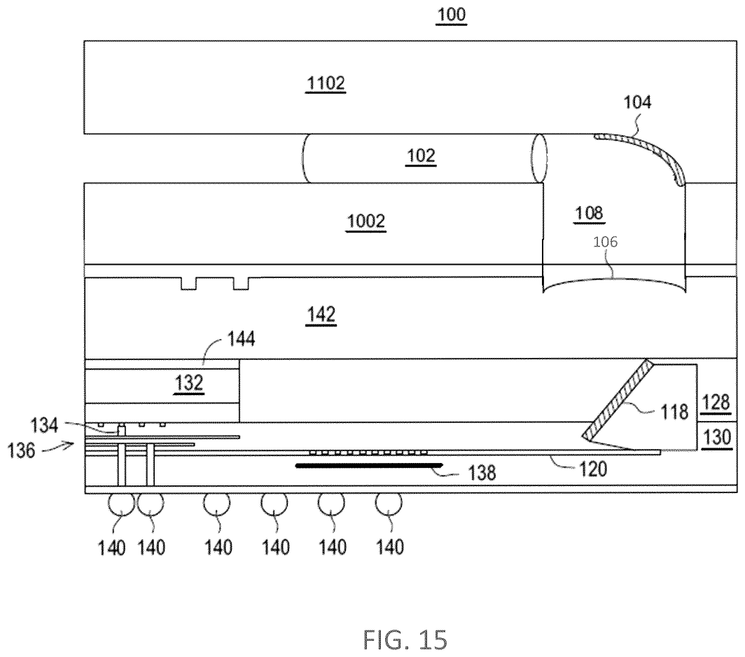

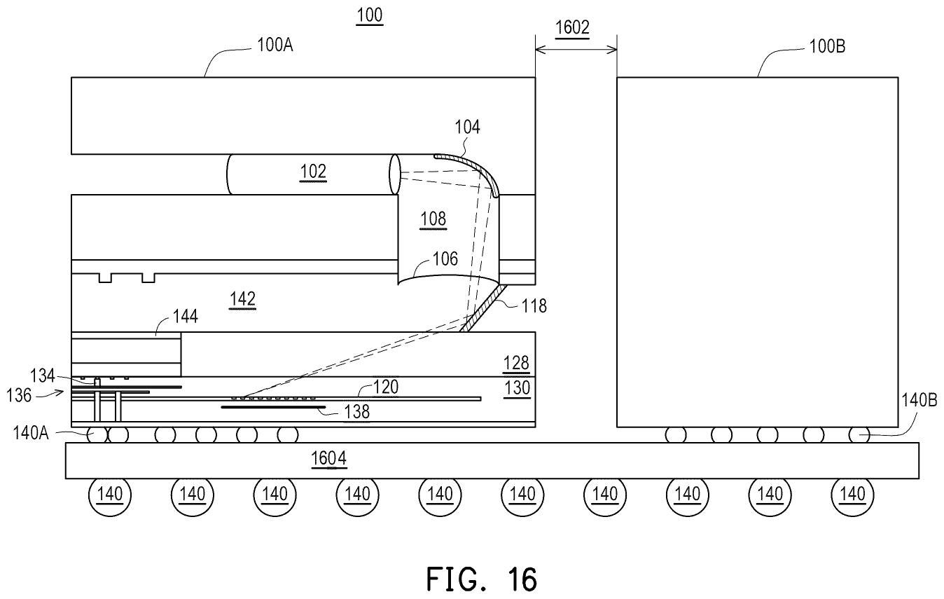

Corresponding to operation 506 of FIG. 5, FIG. 13 illustrates a device (e.g., a semiconductor device 100) including a mirror 118. The mirror 118 can be formed according to various techniques, some examples of which are described above with regard to FIG. 9. However, the mirror 118 is formed in at least one of the p-die 130 or the oxide layer 128. Accordingly, such a mirror can be formed by backside etching the p-die 130 (e.g., prior to forming the device terminals 140), or according to further removal techniques known in the art, some examples of which are described with regard to, for example, FIG. 9 or FIG. 12. The depicted mirror 118 can be configured to receive light from a tuning mirror 104, and to focus that received light upon the grating coupler 120. Such a tuning mirror 104 can be implemented in various geometries. An example of such a tuning mirror 104 is depicted henceforth in FIGS. 14 and 15. However, the depicted example should not be construed as limiting. For example, further implementation can generate a flat tuning mirror 104 (e.g., as depicted in FIG. 3, above).

Referring now to FIG. 14, the adhesive 1002 is coupled with the silicon-containing layer 142 (e.g., the substrate 602). This adhesive 1002 can be provided as a permanent or de-bondable adhesive 1002. For example, the adhesive 1002 can be provided as described above with regard to FIG. 10.

Referring now to FIG. 15, a light source 102, tuning mirror 104, and carrier substrate 1102 are coupled with the semiconductor device 100 (e.g., using the adhesive layer 1002). The light source 102 and tuning mirror 104 can be configured to provide light to the further depicted mirror 118. For example, the light, as lensed by the lensing feature, can be focused on the grating coupler 120 via the mirror 118. The light source 102, tuning mirror 104, and carrier substrate 1102 can be provided as described throughout the present disclosure (e.g., according to the above description of FIG. 11).

With further correspondence to the method 500 of FIG. 5, FIG. 14 illustrates a semiconductor device 100 which can be formed using various embodiments of a first semiconductor device 100A according to the present disclosure. For example, the depicted semiconductor device 100 can include constituent portions of a first semiconductor device 100A (e.g., the semiconductor device 100 of FIGS. 1-3) and a second semiconductor device 100B laterally spaced therefrom. The first semiconductor device 100A can include numerous of the depicted instances of the optical circuit (e.g., thousands or millions). However, the lateral spacing 1402 can be provided as less than a minimum spacing for an edge coupling process. However, the light sources can be provided to the first semiconductor device 100A via an upper surface, as may include a vertical extension distal from the surface, and a lateral extension proximal to the surface.

The first semiconductor device 100A can couple with a substrate 1404, such as an interposer, circuit board, or other connection for a multichip module via device terminals 140A. The second semiconductor device 100B can couple with the substrate 1404 via further device terminals 140B. In some embodiments, the substrate 1404 includes further device terminals 140 configure to couple with a further substrate or other devices. The device terminal 140 interconnections between the various portions can include power, clock, data, memory, and other interconnections configured to exchange computational signals to combine, store, or otherwise process data. For example, such processing can include any combination of electrical and optical signals. Of course, the depicted example is merely illustrative and various further combinations of devices are contemplated. For example, devices can be coupled via die or wafer bonding, or other interconnect methods.

In one aspect of the present disclosure, a semiconductor device is provided. The semiconductor device include a photonic die including a waveguide. The semiconductor device includes an electronic die coupled with and vertically spaced from the photonic die. The semiconductor device includes a silicon-containing layer, having a lensing feature to collimate light from a light source disposed over the electronic die. The semiconductor device includes a first mirror (e.g., disposed in the silicon-containing layer or beside the electronic die). The first mirror can redirect light received from the lensing feature to the waveguide.

In another aspect of the present disclosure, a method of semiconductor device fabrication is provided. The method includes providing a device including a photonic die having a grating coupler. The method includes patterning an upper surface of the device to form a lensing feature configured to receive light from an upper surface of the photonic die. The method includes forming a first mirror configured to optically couple the lensing feature with the grating coupler according to an angle of incidence between the light and the grating coupler of less than about 15 degrees.

In another aspect of the present disclosure, a method of optical coupling is provided. The method includes redirecting, by a first mirror, light received from a light source towards a lensing feature disposed vertically below the light source. The method includes collimating, by the lensing feature, the light. The method includes redirecting, by a second mirror, the collimated light towards a grating coupler to couple the light with a waveguide.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A semiconductor device, comprising:
a photonic die comprising a waveguide;
an electronic die coupled with and vertically spaced from the photonic die;
a silicon-containing layer having a lensing feature configured to collimate light from a light source disposed over the electronic die; and
a first mirror configured to redirect light received from the lensing feature to the waveguide.

2. The semiconductor device of claim 1, further comprising:
a grating coupler to inject the light received from the lensing feature to the waveguide, wherein the first mirror is disposed in the silicon containing layer or beside the electronic die.

3. The semiconductor device of claim 1, further comprising:
the light source; and
a second mirror laterally spaced from the light source and optically coupled with the first mirror via an air gap.

4. The semiconductor device of claim 3, wherein the second mirror is a curved mirror.

5. The semiconductor device of claim 3, further comprising:
an alignment feature configured to align a first portion of the semiconductor device including the first mirror, the photonic die, and the electronic die with a second portion of the semiconductor device including the second mirror and the light source.

6. A method for fabricating semiconductor devices, comprising:
providing a device including a photonic die having a grating coupler;
patterning an upper surface of the device to form a lensing feature configured to receive light from an upper surface of the photonic die; and
forming a first mirror configured to optically couple the lensing feature with the grating coupler according to an angle of incidence between the light and the grating coupler of less than about 15 degrees.

7. The method of claim 6, further comprising:
coupling the photonic die with an electronic die to form the device, wherein a lower surface of the electronic die is coupled with the upper surface of the photonic die, and a dielectric layer separates the lensing feature from the photonic die, wherein the light passes from the first mirror to the grating coupler through the dielectric layer.

8. The method of claim 7, wherein the lensing feature and the first mirror are formed in a silicon-containing layer formed over the dielectric layer.

9. The method of claim 7, further comprising forming the first mirror below a silicon-containing layer, in at least one of:
the dielectric layer; or
the photonic die.

10. The method of claim 6, further comprising:
optically coupling a light source configured to pass the light along a lateral surface of the device with the lensing feature.

11. The method of claim 10, wherein the optical coupling between the light source and the lensing feature includes a second mirror laterally spaced from the light source and vertically spaced from the first mirror.

12. The method of claim 11, further comprising:
coupling the light source and the second mirror with the device using a de-bondable adhesive;
testing, with the light source, the photonic die or an electronic die coupled with the photonic die; and
de-bonding the de-bondable adhesive to remove the light source from the photonic die or the electronic die.

13. The method of claim 11, further comprising:
coupling the light source and the second mirror with the device using a permanent bonding adhesive, wherein the light source is an operational component of the semiconductor device.

14. The method of claim 11, wherein:
the second mirror has a curved surface to focus the light at the first mirror; and
the lensing feature is configured to collimate the light at a planar surface of the first mirror.

15. The method of claim 10, further comprising:
etching an alignment feature during a same etching process as the lensing feature; and
coupling the light source with the device based on the alignment feature.

16. The method of claim 10, wherein the light source comprises an optical fiber, wherein at least a portion of the optical fiber extends parallel to the lateral surface of the semiconductor device.

17. A method of optical coupling comprising:
redirecting, by a first mirror, light received from a light source towards a lensing feature disposed vertically below the light source;
collimating, by the lensing feature, the light; and
redirecting, by a second mirror, the collimated light towards a grating coupler to couple the light with a waveguide.

18. The method of claim 17, wherein an angle of incidence between a lateral surface of the grating coupler and the light is less than about 15 degrees.

19. The method of claim 17, wherein redirecting the light received from the light source comprises:
converging the light towards a focal point on a planar surface of the second mirror according to a curved surface of the first mirror.

20. The method of claim 17, further comprising:
providing an indication of a detection of the light to an electronic die using a bonded photonic via structure communicatively coupling the photonic die with the electronic die.
